(19) United States
(12) Patent Application Publication
(10) Pub. No.: US 2013/0058209 A1
(43) Pub. Date: Mar. 7, 2013

(54) SYSTEM AND METHOD FOR HIGH AVAILABILITY MACHINE-TO-MACHINE MANAGEMENT

(71) Applicants: Zhongwen Zhu, Saint-Laurent (CA); Claes Göran Robert Edström, Beaconsfield (CA)

(72) Inventors: Zhongwen Zhu, Saint-Laurent (CA); Claes Göran Robert Edström, Beaconsfield (CA)

(73) Assignee: TELEFONAKTIEBOLAGET L M ERICSSON (PUBL), Stockholm (SE)

(21) Appl. No.: 13/223,860

(22) Filed: Sep. 1, 2011

(51) Int. Cl. H04W 88/16; H04L 12/26; H04L 12/56

(52) U.S. Cl. 370/221; 370/401; 370/338

(57) ABSTRACT

A high availability management system for machine-to-machine (M2M) gateways is provided. A cluster of mobile stations, which act as M2M gateways for a number of M2M devices, form a virtual high availability management pool which provides access to a telecommunications network. A network messaging center detects the failure or unavailability of an M2M gateway and initiates a failover procedure to transfer the gateway responsibility for the devices connected to the unavailable gateway. An M2M management server identifies a failover mobile station associated with the unavailable mobile station and initiates the transfer of the gateway responsibilities from the unavailable mobile station to the identified failover mobile station.

### TECHNICAL FIELD

The present invention relates generally to procedures and mechanisms for providing a high availability management pool in a smart metering system.

### BACKGROUND

Wireless communication is extending beyond the traditional mobile voice and data devices. Unlike these traditional devices, machine-to-machine (M2M) devices, also known as Machine-Type Communication (MTC) devices, wirelessly communicate with little or no human intervention. For example, an M2M device may autonomously collect and send information to a supporting M2M server via a wireless communication network. This machine communication broadens the reach of useful wireless services to include smart utility consumption applications, like smart utility metering.

In a conventional arrangement, smart metering involves M2M devices that can dynamically monitor and report utility consumption details to a centralized management server at a utility company (e.g., an electric company, a gas company, a water company, or other provider). M2M devices can also receive communications from the centralized management server, such as pricing information or operating instructions.

When an operator network (i.e. Global System for Mobile Communications (GSM) or 3rd generation (3G) mobile telecommunications) is used as the transportation layer for smart metering, one or more meter devices are connected to a single Mobile Station International Subscriber Directory Number (MSISDN) unit in order to access the telecommunications network. Each MSISDN unit requires management and maintenance service from the operator. This single access point to the network for the smart meter device(s) can potentially cause problems for the smart metering management system if the MSISDN unit is not functioning or is otherwise unavailable. In this scenario, all devices connected to the failed MSISDN unit are no longer visible to the smart metering management system.

Accordingly, it should be readily appreciated that in order to overcome the deficiencies and shortcomings of the existing solutions, it would be advantageous to have a solution for avoiding the negative consequences of a single point failure of the smart metering system.

### SUMMARY

It is an object of the present invention to obviate or mitigate at least one disadvantage of the prior art.

In a first aspect of the present invention there is provided a method for detecting an unavailability of a machine-to-machine (M2M) gateway by a messaging center in a communication network, comprising receiving a heartbeat message addressed to a first mobile station that acts as an M2M gateway for one or more M2M devices; forwarding the received heartbeat message to the first mobile station; detecting an unavailability of the first mobile station in response to the heartbeat message; and sending an indication of the unavailability of the first mobile station to trigger a transfer of a gateway responsibility for the one or more M2M devices from the first mobile station to a second mobile station, in response to detecting the unavailability of the first mobile station. The heartbeat message can be a Short Message Service (SMS) message. The heartbeat message can be received from a peer M2M gateway associated with the first mobile station. The step of detecting the unavailability of the first mobile station can include not receiving a delivery acknowledgement from the mobile station within a pre-determined period of time after the forwarding of the heartbeat message to the first mobile station. The indication of the unavailability of the first mobile station can be sent to an M2M server in the communication network.

In another aspect of the present invention there is provided a method for initiating a failover procedure by a machine-to-machine (M2M) server in a communication network, comprising receiving an indication of an unavailability of a first mobile station that acts as an M2M gateway for one or more M2M devices; identifying a failover mobile station associated with the first mobile station, in response to receiving the indication of the unavailability of the first mobile station; and initiating a transfer of a gateway responsibility for the one or more M2M devices associated from the first mobile station to the identified failover mobile station. The indication of the unavailability of the first mobile station can be received from a messaging center in the communication network. The step of identifying the failover mobile station can include selecting the failover mobile station from a plurality of failover mobile stations associated with the first mobile station. The step of initiating the transfer of gateway responsibilities can include sending an instruction to take over gateway responsibility for at least one M2M device to the identified failover mobile station. The instruction can include an identifier for the at least one M2M device. The instruction can include connection information associated with the one or more M2M devices.

In another aspect of the present invention there is provided a messaging center in a communication network, comprising a communication interface for receiving a heartbeat message addressed to a first mobile station that acts as a machine-to-machine (M2M) gateway for at least one M2M device, and for forwarding the received heartbeat message to the first mobile station; and a processor for detecting an unavailability of the first mobile station, and, in response to detecting the unavailability of the first mobile station, instructing the communication interface to send an indication of the unavailability of the first mobile station to trigger a transfer of a gateway responsibility for the at least one M2M device from the first mobile station to a second mobile station. The heartbeat message can be a Short Message Service (SMS) message received from a peer M2M gateway associated with the first mobile station. The processor can detect the unavailability of the first mobile station in accordance with the communication interface not receiving a delivery acknowledgement from the first mobile station in response to the forwarded heartbeat message. The processor can detect the unavailability of the first mobile station in accordance with the communication interface receiving an error message from the first mobile device.

In another aspect of the present invention there is provided a machine-to-machine (M2M) server in a communication network, comprising a communication interface for receiving an indication of an unavailability of a first mobile station that acts as an M2M gateway for at least one M2M device; a memory for storing an identity of at least one failover mobile station associated with the first mobile station; and a processor for selecting a failover mobile station from the memory, in response to receiving the indication of the unavailability of the first mobile station, and for initiating a transfer of a gateway responsibility for the at least one M2M device from the first mobile station to the selected failover mobile station. The indication of the unavailability of the first mobile station can be received from a messaging center in the communication network. The processor can instruct the communication interface to send an instruction to the selected failover mobile station to take over gateway responsibility for the at least one M2M device. The instruction can include an identifier for the at least one M2M device. The instruction can include connection information associated with at least one M2M device.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustrating a Virtual High Availability Management Pool of MSISDN units;

FIG. 2 is a block diagram illustrating an M2M smart metering system;

FIG. 3 is a signal flow diagram illustrating detecting an unavailable MSISDN unit and initiating a recovery procedure;

FIG. 4 is a flow chart illustrating a method for detecting the unavailability of an M2M gateway by a messaging center;

FIG. 5 is a flow chart illustrating a method for initiating a failover procedure by an M2M server; and

FIG. 6 is a block diagram illustrating a network node.

### DETAILED DESCRIPTION

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

The present invention is generally directed to a system and method for detecting a gateway failure and initiating a failover procedure in a smart metering M2M system.

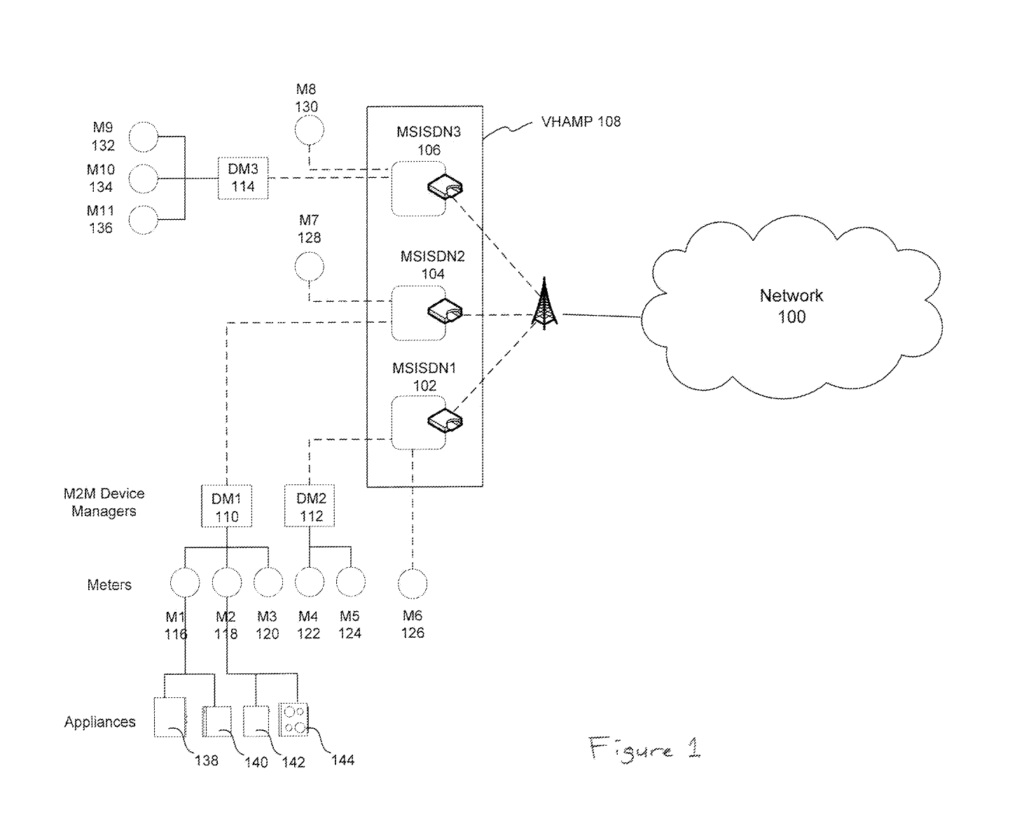

Referring now to FIG. 1, a cluster of MSISDN units 102, 104 and 106 which provide access points to the telecommunications network 100 form a Virtual High Availability Management Pool (VHAMP) 108. An MSISDN unit can be any mobile station or mobile device that acts as a gateway for MSISDN units 102, 104 and 106 to the network 100. It will be appreciated that the terms “MSISDN unit” and “mobile station” will be used interchangeably. Each MSISDN unit connects to one or more meter devices (M1-M11 116-136) directly or indirectly through an M2M device manager (DM1-DM3 110-114). All of the connection information between a specific device and an MSISDN unit (e.g. device identity, address, MSISDN unit identity, protocol, etc.) is stored in the MSISDN unit and this information is exchanged among all of the MSISDN units in the VHAMP 108. When one MSISDN units crashes or fails, the corresponding connection information can be recovered from the remaining MSISDN units and be used to connect the devices to one of the remaining MSISDN units of the VHAMP 108, which is assigned for the recovery task. An MSISDN unit can be any mobile station or mobile device that acts

The first MSISDN unit 102 manages the network access for meter device M6 126 and M2M device manager DM2 112. M2M device manager DM2 112 manages meter devices M4 122 and M5 124. Similarly, the second MSISDN unit 104 manages the network access for meter device M7 128 and meters M1 116, M2 118 and M3 120 through M2M device manager DM1 110. The third MSISDN unit 106 manages the network access for meter device M8 130 and meters M9 132, M10 134 and M11 136 through M2M device manager DM3 114.

The M2M device managers can coordinate the operation and signaling of the meter devices they manage. The M2M device managers can store a set of policy-based rules which governs the response of the M2M device manager to any received operating information and the particular manner in which the meter device(s) is to be controlled. The M2M device managers can also collect operating information from the devices it manages and aggregate, evaluate and/or queue the information for communication to the network.

Some smart meter devices can be responsible for metering multiple appliances in a home. For example, meter M1 116 is connected to appliances 138 and 140 and meter M2 118 is connected to appliances 142 and 144.

The meter devices and M2M device managers can communicate wirelessly with their respective MSISDN units via WiFi, Bluetooth or any other appropriate form of radio frequency, microwave or infrared communication. Different groups of meter devices and M2M device managers may include devices of different types, devices in different locations, and devices that use different communication protocols. Meter devices 116 and 118 can be located in a single home or Local Area Network (LAN), or alternatively they can be distributed through multiple LANs.

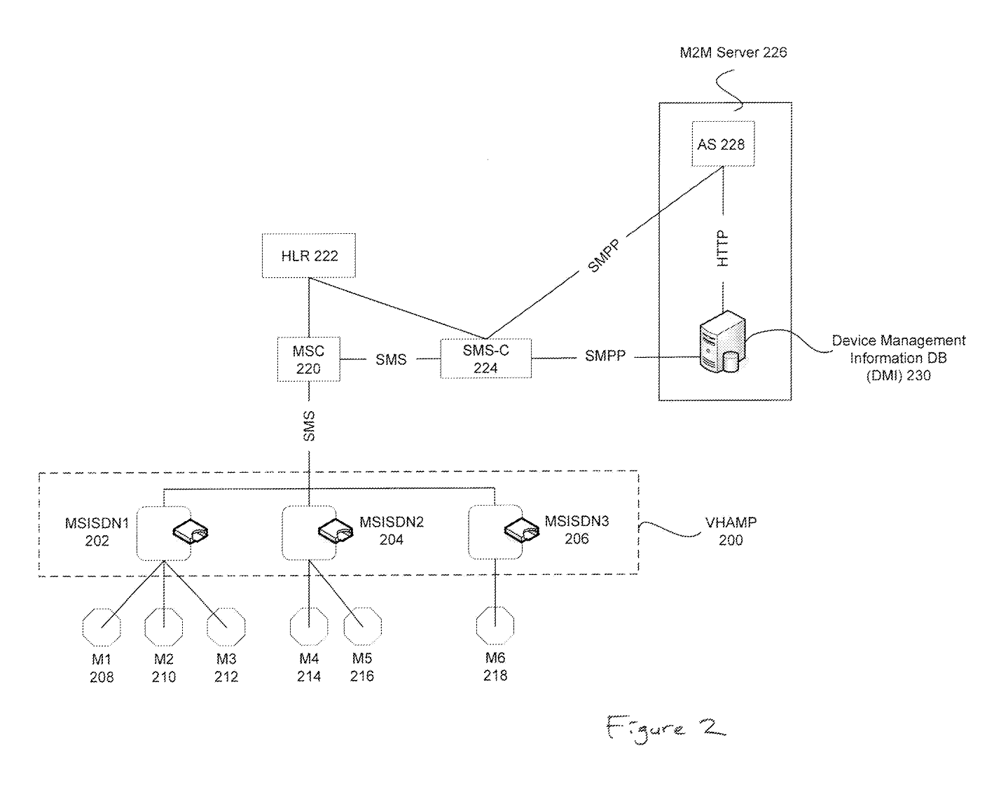

FIG. 2 is an example embodiment of the present invention illustrating the communication between various nodes of the M2M smart metering system and a GSM network including the Mobile Switching Center (MSC) 220, the Home Location Register (HLR) 222, the Short Message Service Center (SMS-C) 224 and the M2M server 226. The M2M server 226 manages the smart metering system and can include an Application Server (AS) 228 and a Device Management Information database (DMI) 230. In general, the MSC 220 is the primary service delivery node for the network, responsible for routing voice calls and SMS. The HLR 222 is a central database that contains details of each mobile device that is authorized to use the network. The SMS-C 224 is responsible for handling the SMS operations of the network. When an SMS message is sent from a mobile device, it is received by the SMS-C 224 then forwarded towards the destination. For clarity, certain details regarding the control signaling between these nodes will be omitted or not be explained in detail.

MSISDN1 202 acts as a gateway for M2M meter devices M1 208, M2 210 and M3 212. MSISDN2 204 acts as a gateway for M2M meter devices M4 214 and M5 216. MSISDN3 206 acts as a gateway for M2M meter device M6 218.

The MSISDN units 202, 204, 206 in the VHAMP cluster 200 are configured to communicate with each other by means of SMS messages. In order for the VHAMP 200 to know which MSISDN units are available and properly functioning, a heartbeat message is passed between the MSISDN units 202, 204, 206. This heartbeat message can be sent by means of an SMS. The body, or payload, of the SMS can indicate that it is a heartbeat message related to the VHAMP and any other applicable information. Heartbeat messages are typically sent non-stop on a periodic or recurring basis to enable an originator or a destination to identify if and when a peer fails or is no longer available. For example, MSISDN1 202 sends a heartbeat SMS message addressed to MSISDN2 202. The SMS is received by the MSC 220 and forwarded to the SMS-C 224 which locates the recipient details for MSISDN2 204 in the HLR 222. The SMS-C 224 then forwards the SMS to MSISDN 204 via the MSC 220.

When MSISDN2 204 receives the heartbeat message from MSISDN1 202, it acknowledges the receipt by sending a success response back the SMS-C 224. After acknowledging the message, it will send a new heartbeat SMS to the next MSISDN unit in the VHAMP 200 list (e.g. MSISDN3 206). The order of communication between the MSISDN units is managed by the M2M server 226 and stored in the DMI 230. Each MSISDN unit can store identity information for its subsequent MSISDN unit on the list in order to be able to address the heartbeat SMS messages.

Alternatively, each MSISDN unit can be pinged with a heartbeat message from at least one other MSISDN unit in the VHAMP 200 or with a heartbeat message originating from the M2M server 226.

When the SMS-C 224 detects that an MSISDN unit has failed to receive a heartbeat SMS, or has become otherwise unavailable, the SMS-C 224 will report the unavailability to the M2M server 226. The SMS-C 224 and the M2M server 226 can communicate with each other using Short Message Peer-to-Peer (SMPP) protocol, a protocol for exchanging SMS messages between SMS peer entities. Conventionally, an SMS-C will receive an acknowledgement of receipt from the receiver following delivery of an SMS message. If an SMS-C does not receive a delivery acknowledgement, it will continue to try delivering the SMS for a number of attempts, after which, it will discard the message. The SMS-C 224 can detect a failed delivery upon not receiving an acknowledgement after a predetermined amount of time or a predetermined number of delivery attempts. When the M2M server 226 receives notice of a heartbeat message delivery failure, it initiates a recovery procedure to connect the devices of the non-responsive MSISDN unit to other available MSISDN units in the VHAMP 200. The corresponding connection information between the devices and the unavailable MSISDN unit can be recovered by the remaining VHAMP 200 members and the M2M server 226 and can be used to connect the devices to a functioning MSISDN unit assigned for the recovery task. It will be appreciated by those skilled in the art that all devices connected to an unavailable MSISDN unit may not be required to be taken-over by one single MSISDN unit. The devices can be distributed among multiple MSISDN units in the VHAMP 200 cluster for recovery.

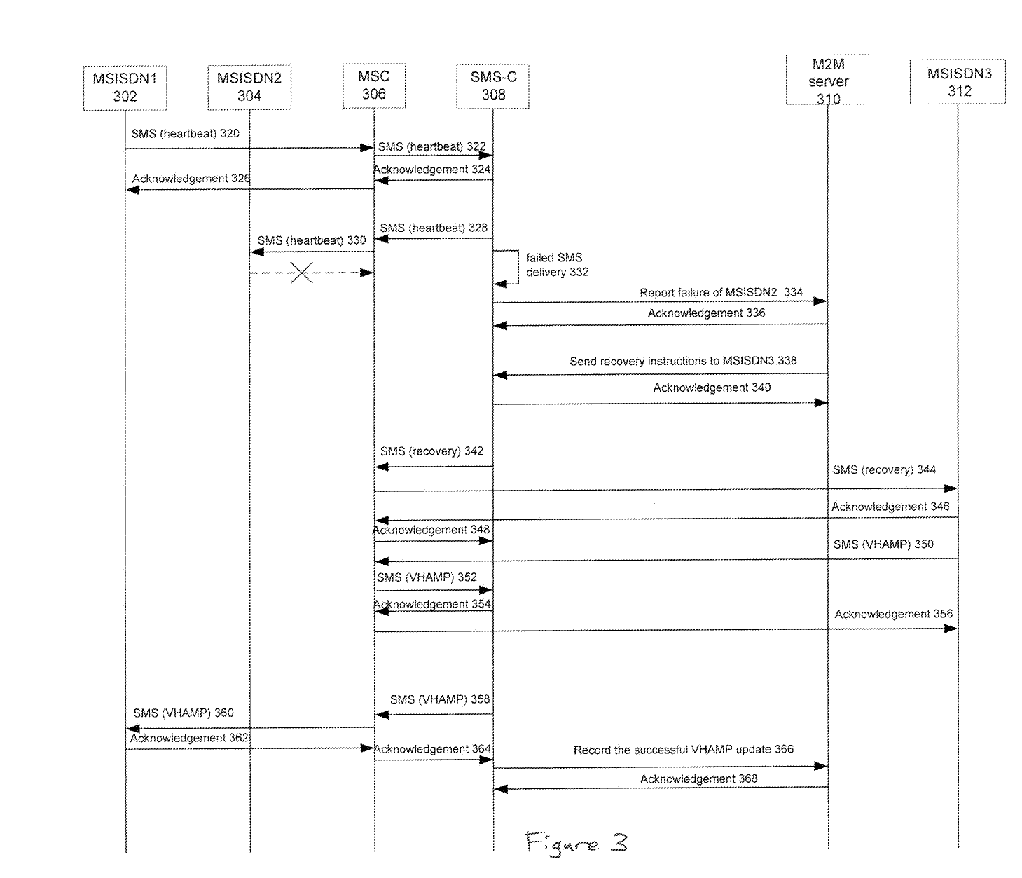

FIG. 3 is a signal flow diagram illustrating an embodiment for detecting that an MSISDN unit is not functioning and initiating a recovery procedure. MSISDN units 302, 304 and 312 are members of a VHAMP cluster. The MSC 306, SMS-C 308 and M2M server 310 nodes are involved in network signaling.

MSISDN1 302 sends a heartbeat message via SMS 320 addressed to MSISDN2 304. The message is received by the MSC 306 and forwarded 322 to the SMS-C 308. The SMS-C 308 acknowledges the receipt of the heartbeat message with Acknowledgement message 324 which the MSC 306 returns to MSISDN1 302 as Acknowledgement 326. Acknowledgement 324, 326 is simply an acknowledgement that the network has received SMS 320 and does not indicate that SMS 320 has been delivered to its ultimate destination. The SMS 328 is forwarded to the MSC 306 for delivery to MSISDN2 304 as message 330. In step 332, the SMS-C 308 waits to receive acknowledgement that SMS 330 has been received by MSISDN2 304. The SMS-C 308 can optionally retry sending SMS 330 a number of times if no acknowledgement has been received. The SMS-C 308 then determines a delivery failure of the heartbeat message 330, and thus an unavailability of MSISDN2 304. In response to detecting this delivery failure, the SMS-C 308 sends a report 334 of the unavailability of MSISDN2 304 to the M2M server 310. M2M server 310 responds with acknowledgement message 336.

The M2M server 310 identifies and selects MSISDN3 312 to take over for the failed MSISDN2 304. M2M server 310 sends a message 338 to instruct the SMS-C 308 to inform MSISDN3 312, and acknowledgement 340 is returned. Instruction 338 can include the identity of the unavailable MSISDN unit (i.e. MSISDN2 304), identities of the devices attached to MSISDN2 304, and the identity of the MSISDN unit which originated the heartbeat message to MSISDN2 304 (i.e. MSISDN1 303). Optionally, instruction 338 can include connection information for the devices attached to the unavailable MSISDN unit. Optionally, instruction 338 can also include identities of other MSISDN units which need to be informed of the failure event. In accordance with the received instruction 338, the SMS-C 308 sends an SMS 342 to MSISDN3 312 to indicate recovery information for the devices requiring a MSISDN unit, which the MSC 306 forwards as SMS 344. SMS messages 342, 344 include all pertinent information from instruction 338 that is required by MSISDN3 to initiate taking over gateway responsibilities for MSISDN2 304. MSISDN3 312 acknowledges 346 the receipt of the SMS 344, and the MSC 306 forwards the acknowledgement 348 to the SMS-C 308.

MSISDN3 312 can now use the connection information for the indicated devices to connect and act as their gateway to the network. The specific connection information for each device can be included in the received SMS message 344 or alternatively, it can already be stored in MSISDN3 312. MSISDN3 312 then initiates a message 350 to MSISDN1 302 to update the VHAMP with the information that MSISDN2 is unavailable and MSISDN3 312 has taken over gateway responsibilities for the devices of MSISDN2 304. The MSC 306 forwards the message as SMS 352. The SMS-C 308 acknowledges 354, 356 that it has received the message from MSISDN3 312, and forwards the SMS 358, 360 to MSISDN1 302. MSISDN1 312 acknowledges that it has updated its VHAMP information via messages 362 and 364. In response to receiving acknowledgement 364, the SMS-C 308 instructs the M2M server 310 to record and store the successful updating of the VHAMP 366. The M2M server 310 returns acknowledgement 368 of the VHAMP update to the SMS-C 308.

Optionally, SMS 350 can be a group SMS addressed to both MSISDN1 302 and the M2M server 310 to update the VHAMP. In this scenario, messages 358 and 366 can be sent in parallel. There is no need to receive acknowledgement 364 prior to sending instruction 366.

Optionally, in the case where the VHAMP includes additional MSISDN units, SMS 350 can be a group SMS sent to all the other available MSISDN units of the VHAMP to update their VHAMP information.

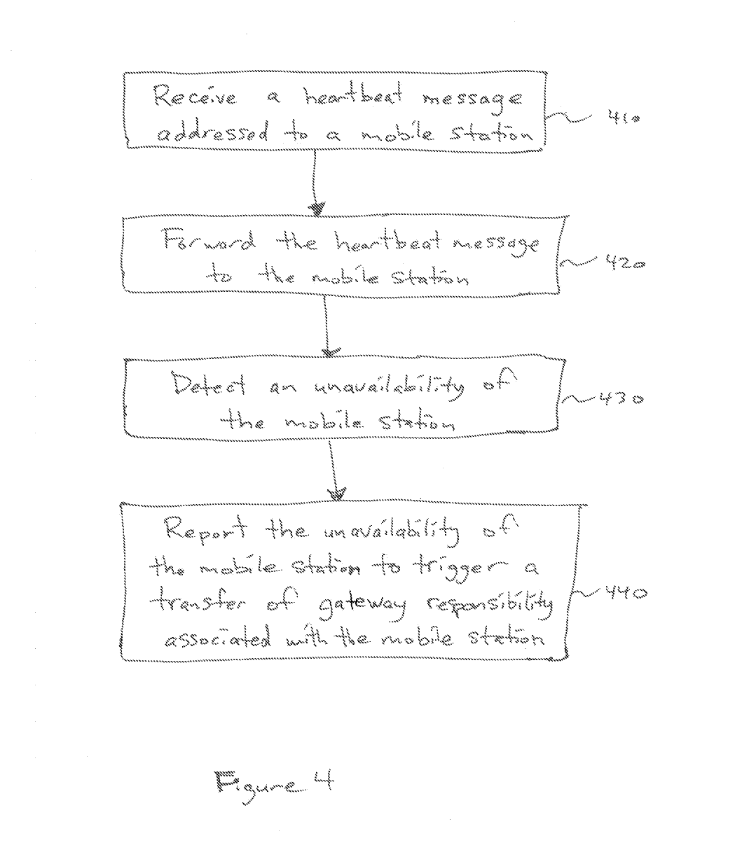

FIG. 4 is a flow chart illustrating a method for detecting the unavailability of an M2M gateway by a messaging center in a communication network. The messaging center can be an SMS-C. In step 410, the messaging center receives a heartbeat message addressed to a mobile station that acts as an M2M gateway for one or more M2M devices. The heartbeat message can be an SMS message. The heartbeat message can be received from another mobile station in the network that also acts as an M2M gateway for at least one M2M device. In step 420, the messaging center forwards the received heartbeat message to the mobile station. In step 430, the messaging center detects that the mobile station is unavailable. The detection of the unavailability of the mobile station can be determined in response to receipt of a delivery failure message for the forwarded heartbeat message. Alternatively, the messaging center can determine that the mobile station is unavailable in response to a lack of receiving an acknowledgment message for receipt of the forwarded heartbeat message from the mobile station. It will be appreciated by those skilled in the art that a status of unavailable indicates that the mobile station has failed or is not functioning properly. In response to detecting the unavailability of the mobile station, in step 430, the messaging center reports the unavailability of the mobile station in order to trigger a transfer of the gateway responsibility for the one or more M2M devices from the mobile station to another available mobile station. Step 430 can include sending an indication of the unavailability of the mobile station to an M2M server in the communication network, along with the identity of the unavailable mobile station.

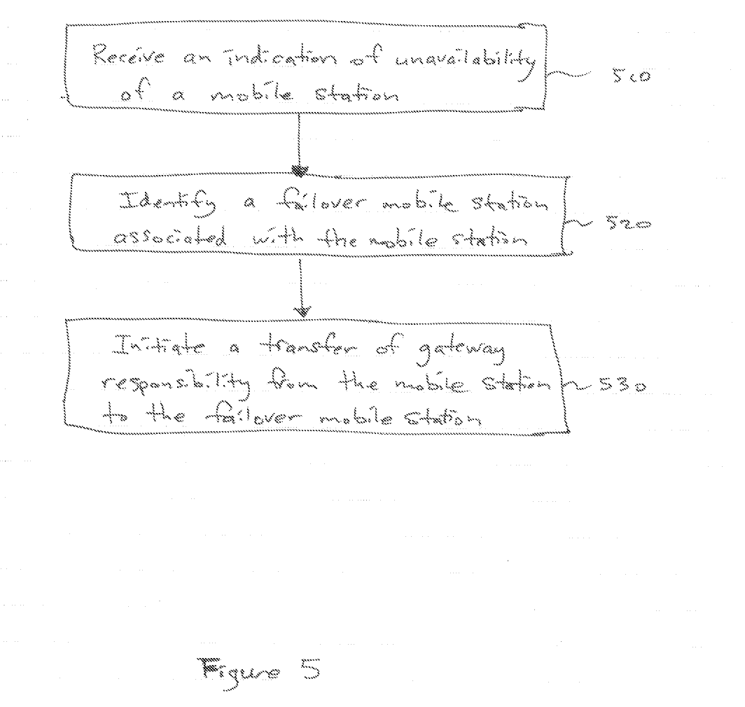

FIG. 5 is a flow chart illustrating a method for initiating a failover procedure by an M2M server in a communication network. In step 510, the M2M server receives an indication of unavailability of a mobile station that acts as an M2M gateway for one or more M2M devices. The indication of unavailability can be received from a messaging center such as an SMS-C. In response to receiving the indication of unavailability, in step 520, the M2M server identifies a failover mobile station that is associated with the first mobile station and capable of acting as an M2M gateway for the one or more M2M devices. Identifying a failover mobile station can include looking up available mobile stations associated with the unavailable mobile station in a database. The failover mobile station can be selected from a number of failover mobile stations associated with the unavailable mobile station. In step 530, the M2M server initiates a transfer of the gateway responsibility for at least one of the M2M devices associated with the mobile station to the identified failover mobile station. Initiation of the transfer gateway responsibilities can include sending a message to the identified failover mobile station. The message can include instructions to begin acting as a gateway for the at least one M2M device previously connected to the unavailable mobile station. The message can include identification and connection information related to M2M device(s) to be transferred.

Although some embodiments have been described as implemented using SMS messages, it will be appreciated that other forms of messaging including Multimedia Messaging Service (MMS) and Instant Messaging (IM) can be used.

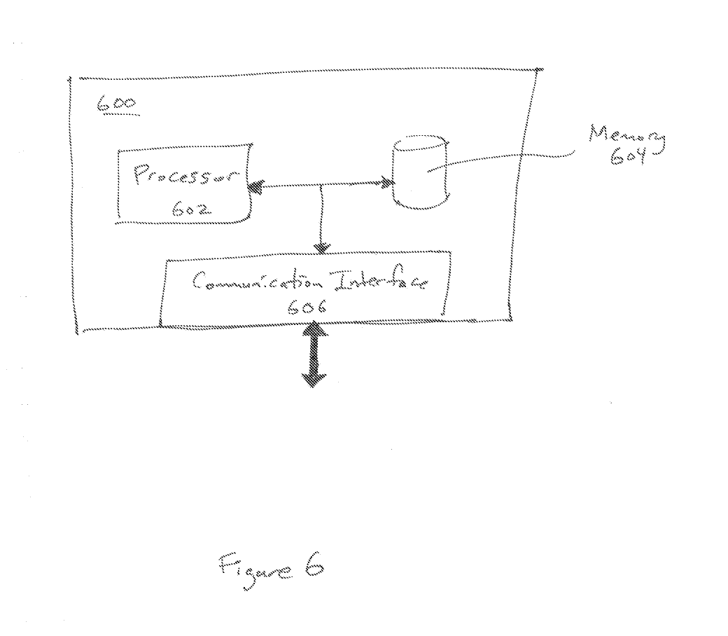

FIG. 6 is a block diagram illustrating a network node 600 which can be used to implement the various embodiments as described herein, comprising a processor 602, a memory 604 and a communication interface 606. The memory 604 can store instructions that, when executed by the processor 602, enable the node 600 to perform the functions of a messaging center or an M2M server as described herein.

Node 600 can be a network messaging center such as an SMS-C. The communication interface 606 can receive a heartbeat message addressed to a mobile station that acts as a gateway for at least one M2M device, such as a smart meter. The heartbeat message can be an SMS message. The SMS message can be received from a peer M2M gateway in the communication network. The communication interface 606 forwards the received heartbeat message to the mobile station. The processor 602 can detect an unavailability of the mobile station. The detection of unavailability can be made in response to not receiving an acknowledgement in response to the forwarded heartbeat message. Alternatively, the detection of unavailability can be made in response to receiving an error message by the communication interface 606. The error message can indicate a deliver failure of the forwarded heartbeat message or an indication that the mobile station is not capable of handling the heartbeat message due to overload, capacity issue, or other malfunction. In response to detecting the unavailability of the mobile station, the processor 602 instructs the communication interface 606 to send an indication of the unavailability of the mobile station, in order to trigger a transfer of the gateway responsibility for the at least one M2M device from the mobile station to a second mobile station.

In another embodiment, node 600 can be a M2M server. The communication interface 606 can receive an indication of an unavailability of a mobile station that acts as a gateway for at least one M2M device. The indication of unavailability can be received from a messaging center in the communication network. The identity of at least one failover mobile station associated with the mobile station that acts as a gateway for at least one M2M device is stored in the memory 604. In response to receiving the indication of unavailability of the mobile station, the processor 602 selects a failover mobile station from the memory 604 and initiates a transfer of the gateway responsibility for the at least one M2M device from the mobile station to the selected failover mobile station. The processor 602 can instruct the communication interface 604 to send an instruction message to the selected failover mobile station to trigger the transfer of gateway responsibility. The instruction message can include device identifier(s) for all M2M devices that the failover mobile station will take over gateway responsibility for. The instruction message can also include connection information for each of the M2M devices that the failover mobile station will take over gateway responsibility for.

Based upon the foregoing, it should now be apparent to those of ordinary skill in the art that the present invention provides an advantageous solution. Although the system and method of the present invention have been described with particular reference to certain type of messages and nodes, it should be realized upon reference hereto that the innovative teachings contained herein are not necessarily limited thereto and may be implemented advantageously in various manners. It is believed that the operation and construction of the present invention will be apparent from the foregoing description.

Embodiments of the invention may be represented as a software product stored in a non-transitory machine-readable medium (also referred to as a computer-readable medium, a processor-readable medium, or a computer-usable medium having a computer-readable program code embodied therein). The machine-readable medium may be any suitable tangible medium including a magnetic, optical, or electrical storage medium including a diskette, compact disk read only memory (CD-ROM), digital versatile disc read only memory (DVD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those skilled in the art without departing from the scope of the invention, which is defined by the claims appended hereto.

What is claimed is:

1. A method for detecting an unavailability of a machine-to-machine (M2M) gateway by a messaging center in a communication network, comprising:
receiving a heartbeat message addressed to a first mobile station that acts as an M2M gateway for one or more M2M devices;
forwarding the received heartbeat message to the first mobile station;
detecting an unavailability of the first mobile station in response to the heartbeat message; and
sending an indication of the unavailability of the first mobile station to trigger a transfer of a gateway responsibility for the one or more M2M devices from the first mobile station to a second mobile station, in response to detecting the unavailability of the first mobile station.

2. The method of claim 1, wherein the heartbeat message is a Short Message Service (SMS) message.

3. The method of claim 1, wherein the heartbeat message is received from a peer M2M gateway associated with the first mobile station.

4. The method of claim 1, wherein the step of detecting the unavailability of the first mobile station includes not receiving a delivery acknowledgement from the mobile station within a pre-determined period of time after the forwarding of the heartbeat message to the first mobile station.

5. The method of claim 1, wherein the indication of the unavailability of the first mobile station is sent to an M2M server in the communication network.

6. A method for initiating a failover procedure by a machine-to-machine (M2M) server in a communication network, comprising:
receiving an indication of an unavailability of a first mobile station that acts as an M2M gateway for one or more M2M devices;
identifying a failover mobile station associated with the first mobile station, in response to receiving the indication of the unavailability of the first mobile station; and
initiating a transfer of a gateway responsibility for the one or more M2M devices associated from the first mobile station to the identified failover mobile station.

7. The method of claim 6, wherein the indication of the unavailability of the first mobile station is received from a messaging center in the communication network.

8. The method of claim 6, wherein the step of identifying the failover mobile station includes selecting the failover mobile station from a plurality of failover mobile stations associated with the first mobile station.

9. The method of claim 6, wherein the step of initiating the transfer of gateway responsibilities includes sending an instruction to take over gateway responsibility for at least one M2M device to the identified failover mobile station.

10. The method of claim 9, wherein the instruction includes an identifier for the at least one M2M device.

11. The method of claim 9, wherein the instruction includes connection information associated with the one or more M2M devices.

12. A messaging center in a communication network, comprising:
a communication interface for receiving a heartbeat message addressed to a first mobile station that acts as a machine-to-machine (M2M) gateway for at least one M2M device, and for forwarding the received heartbeat message to the first mobile station; and
a processor for detecting an unavailability of the first mobile station, and, in response to detecting the unavailability of the first mobile station, instructing the communication interface to send an indication of the unavailability of the first mobile station to trigger a transfer of a gateway responsibility for the at least one M2M device from the first mobile station to a second mobile station.

13. The messaging center of claim 12, wherein the heartbeat message is a Short Message Service (SMS) message received from a peer M2M gateway associated with the first mobile station.

14. The messaging center of claim 12, wherein the processor detects the unavailability of the first mobile station in accordance with the communication interface not receiving a delivery acknowledgement from the first mobile station in response to the forwarded heartbeat message.

15. The messaging center of claim 12, wherein the processor detects the unavailability of the first mobile station in accordance with the communication interface receiving an error message from the first mobile device.

16. A machine-to-machine (M2M) server in a communication network, comprising:
a communication interface for receiving an indication of an unavailability of a first mobile station that acts as an M2M gateway for at least one M2M device;
a memory for storing an identity of at least one failover mobile station associated with the first mobile station; and
a processor for selecting a failover mobile station from the memory, in response to receiving the indication of the unavailability of the first mobile station, and for initiating a transfer of a gateway responsibility for the at least one M2M device from the first mobile station to the selected failover mobile station.

17. The M2M server of claim 17, wherein the indication of the unavailability of the first mobile station is received from a messaging center in the communication network.

18. The M2M server of claim 17, wherein the processor instructs the communication interface to send an instruction to the selected failover mobile station to take over gateway responsibility for the at least one M2M device.

19. The M2M server of claim 18, wherein the instruction includes an identifier for the at least one M2M device.

20. The M2M server of claim 18, wherein the instruction includes connection information associated with at least one M2M device.
